(19) United States
(12) Patent Application Publication
(10) Pub. No.: US 2006/0260658 A1
(43) Pub. Date: Nov. 23, 2006

(54) Closed-loop containment assembly and method for a pressure washing apparatus with a non-recirculating fluid heating compartment

(75) Inventors: Raymond Niedzwiecki, Palo Alto, CA (US); Neil Jeffrey Bailer, Bridgeport, PA (US); Anthony Rutland, Santa Cruz, CA (US)

Correspondence Address: BEYER WEAVER & THOMAS, LLP, P.O. BOX 70250, OAKLAND, CA, 94612-0250, US

(73) Assignee: EZ ENVIRONMENTAL SOLUTIONS CORPORATION, MENLO PARK, CA (US)

(21) Appl. No.: 11/069,885

(22) Filed: Feb. 28, 2005

(51) Int. Cl. B08B 3/00; A01G 25/09

(52) U.S. Cl. 134/105; 134/108; 134/110; 239/146

(57) ABSTRACT

A closed-loop containment assembly for use with a pressure washing apparatus for washing an object having a contaminant. The containment assembly includes a collection basin adapted to collect the run-off of a washing fluid after being flowed over the object to remove the contaminant. A filter assembly includes an inlet side and an outlet side, wherein the inlet side is in fluid communication with the contaminated washing fluid collected in the basin. A vertically upstanding clarifying tank provides a relatively vertically deep flow path defined by a first baffle wall and a second baffle wall. The first baffle wall downwardly distends from a top portion of the clarifying tank to form an under weir with a bottom portion of the clarifying tank, while the second baffle wall upwardly distends from the bottom portion to form an over weir with the top portion thereof. The clarifying tank includes an inlet fluidly coupled to the outlet side of the filter assembly, and is positioned proximate the top portion and upstream from the under weir. The containment assembly further includes a relatively vertically deep clean fluid reservoir in fluid communication with the over weir of the clarifying tank. The clean fluid reservoir is free of any outlets configured to enable recirculation of clean washing fluid therein directly back into at least one of the filter assembly and the clarifying tank. A heating element is positioned in the clean fluid reservoir to heat the clean washing fluid contained therein.

### BACKGROUND OF THE INVENTION

1. Field of Invention

The present invention relates generally to methods and apparatus for use in pressure washing. More particularly, the present invention relates to methods and apparatus for safely washing objects with a pressure washer apparatus, or similar device, and recovering contaminants from the objects.

2. Description of the Relevant Art

Contamination of the environment by man-made substances has long been considered a serious world-wide problem. Recently, concern about contamination of earth, air, and groundwater by oil, toxic chemicals, and other hazardous wastes has expanded beyond large-scale industry to encompass the activities of many small businesses including automobile service stations, and many others. Both government regulations and social outcry have placed tremendous pressure on these businesses to avoid discharging hazardous wastes into the environment in the course of ordinary business activities.

Many businesses partake in activities that are likely to produce waste that may be harmful to the environment. For example, in an automobile service station, washing or steam-cleaning auto parts, e.g., an automobile engine, often causes engine oil, gasoline, and other chemicals to enter a storm drain system, or other waterways, thereby leading to the potential contamination of groundwater. In addition, those who service remotely located equipment generally have a need to wash the equipment without discharging hazardous waste into the environment. By way of example, persons who service roof-mounted air conditioners that contain lubricating petrochemicals, trapped pollutants, or other chemicals are not permitted to wash the equipment in a manner that could cause chemicals to run off the roof and into the surrounding environment.

High pressure washing equipment, which is typically used to clean auto parts, is generally available. However, many pressure washers do not have containment capability for hazardous materials. Hence, such pressure washers may not prevent hazardous materials from entering the surrounding environment. Some pressure washers may be able to recover some wash fluid, although pressure washers that recover some wash fluid often do not filter hazardous wastes, or do not efficiently filter all hazardous wastes out of the wash fluid. As such, pressure washing systems often generate relatively large volumes of wastewater which must either be processed separately, or placed in barrels for disposal. Further, since such pressure washing systems are often required to handle large volumes of wastewater, the pressure washing systems are not readily transportable.

More recently, to address this problem, portable, zero-discharge wash apparatus have become widely available which may recover oil, chemicals, and other hazardous materials from an object that is being washed. These pressure wash assemblies may efficiently recirculate, heat, and repeatedly filter, a process fluid, thereby minimizing the quantity of waste material produced during a washing process. Typical of such systems are disclosed in U.S. Pat. Nos. 6,120,614; 5,673,715; 5,785,067 and 5,803,982, incorporated herein by reference.

These zero-discharge, closed-loop wash apparatus typically deploy a multi-step contaminant removal process designed to independently remove the larger heavy weight contaminants and the smaller lightweight contaminants from the process fluid. A collection basin of the wash apparatus, for example, may be configured to remove the larger heavyweight contaminants through the application of filtration baskets or through sediment settling of the coarser sediments along the bottom of the collection basin. In other configurations, a clarifying tank may be employed for such larger heavy weight contaminants.

The discharge from these collection basin or tanks may typically flow into some semi-clean fluid reservoir to contain the first stage or semi-cleaned fluids where the smaller medium-weight and lightweight contaminants may still be suspended in the process fluid. These medium-weight and lightweight contaminants are generally flown through a filtration assembly an intake side coupled to the semi-clean fluid containment reservoir and an outlet side coupled to a clean fluid containment reservoir. In some designs, a succession of micron filters may be used to remove successively smaller particulates and molecules from the process fluid.

During periods of non-use, the cleaned washing fluids contained in the clean fluid reservoir are recirculated back into the semi-clean fluid reservoir where the washing fluid is again flown through the filter or filters and back into the clean fluid reservoir. This continued recirculation process ultimately filters the washing fluids contained in both the semi-clean and clean fluid reservoirs. Since the capacity of the semi-clean reservoir is often similar to that of the clean fluid reservoir, after thorough recirculation, the clean washing fluid capacity is often double that of the clean fluid reservoir.

While having an increased capacity of clean washing fluid is often beneficial, there is also an associated downside when heated washing fluids are necessary. Due to the recirculation process, a much greater quantity of washing fluid must actually be heated. Since this capacity often exceeds 50 gallons to 120 gallons, the additional heating requirement is substantial.

Accordingly, it would be desirable to eliminate heating of the fluid contained in the semi-clean containment reservoir, while maintaining the clean fluid quality of the washing fluid in the clean fluid containment reservoir.

### SUMMARY OF THE INVENTION

The present invention relates to a closed-loop containment assembly for use with a pressure washing apparatus for washing an object having a contaminant. The containment assembly includes a collection basin adapted to collect the run-off of a washing fluid after being flowed over the object to remove the contaminant. A filter assembly includes an inlet side and an outlet side, wherein the inlet side is in fluid communication with the contaminated washing fluid collected in the basin. A clarifying tank includes an upper positioned inlet in flow communication with the outlet side of the filter assembly. The tank further includes a baffle assembly defining an under weir at a bottom portion of the clarifying tank and a downstream over weir at an upper portion of the clarifying tank. A relatively vertically deep flow path is formed that flows down under the under weir and up over the over weir. The clarifying tank includes an inlet fluidly coupled to the outlet side of the filter assembly, and is positioned proximate the top portion and upstream from the under weir. The containment assembly further includes a relatively vertically deep clean fluid reservoir in fluid communication with the over weir of the clarifying tank. The clean fluid reservoir is free of any outlets configured to enable recirculation of clean washing fluid therein directly back into at least one of the filter assembly and the clarifying tank. A heating element is positioned in the clean fluid reservoir to heat the clean washing fluid contained therein.

In one specific embodiment, the clarifying tank is vertically upstanding. The baffle assembly includes a first baffle wall downwardly distends from the tank top portion to form the under weir with the tank bottom portion of the clarifying tank. Further, a second baffle wall upwardly distends from the tank bottom portion to form the over weir with the tank top portion thereof.

In another embodiment, the flow path of the clarifying tank is substantially U-shaped. In one configuration, the first baffle wall and the second baffle wall are substantially vertical. In another form, the second baffle wall tapers away from the first baffle wall from the tank bottom portion to the tank top portion.

### BRIEF DESCRIPTION OF THE DRAWINGS

The method and assembly of the present invention has other objects and features of advantage which will be more readily apparent from the following description of the Detailed Description of the Embodiments and the appended claims, when taken in conjunction with the accompanying drawing, in which:

FIG. 1 is a schematic diagram of a closed-loop pressure washing apparatus and containment assembly constructed in accordance with the present invention.

FIG. 2 is an enlarged side elevation view of a washing platform assembly of the containment assembly of FIG. 1.

FIG. 3 is a rear elevation view of the washing platform assembly of FIG. 2, illustrating the components thereof.

FIG. 4 is an enlarged side elevation view, in cross-section, of a clarifying/storage tank of the containment assembly of FIG. 1.

FIG. 5 is a reduced, side elevation view of clarifying/storage tank of FIG. 4.

FIG. 6 is a front elevation view of clarifying/storage tank of FIG. 5.

FIG. 7 is a side elevation view, in cross-section, of an alternative embodiment clarifying/storage tank of that of FIG. 4.

### DETAILED DESCRIPTION OF THE EMBODIMENTS

While the present invention will be described with reference to a few specific embodiments, the description is illustrative of the invention and is not to be construed as limiting the invention. Various modifications to the present invention can be made to the preferred embodiments by those skilled in the art without departing from the true spirit and scope of the invention as defined by the appended claims. It will be noted here that for a better understanding, like components are designated by like reference numerals throughout the various figures.

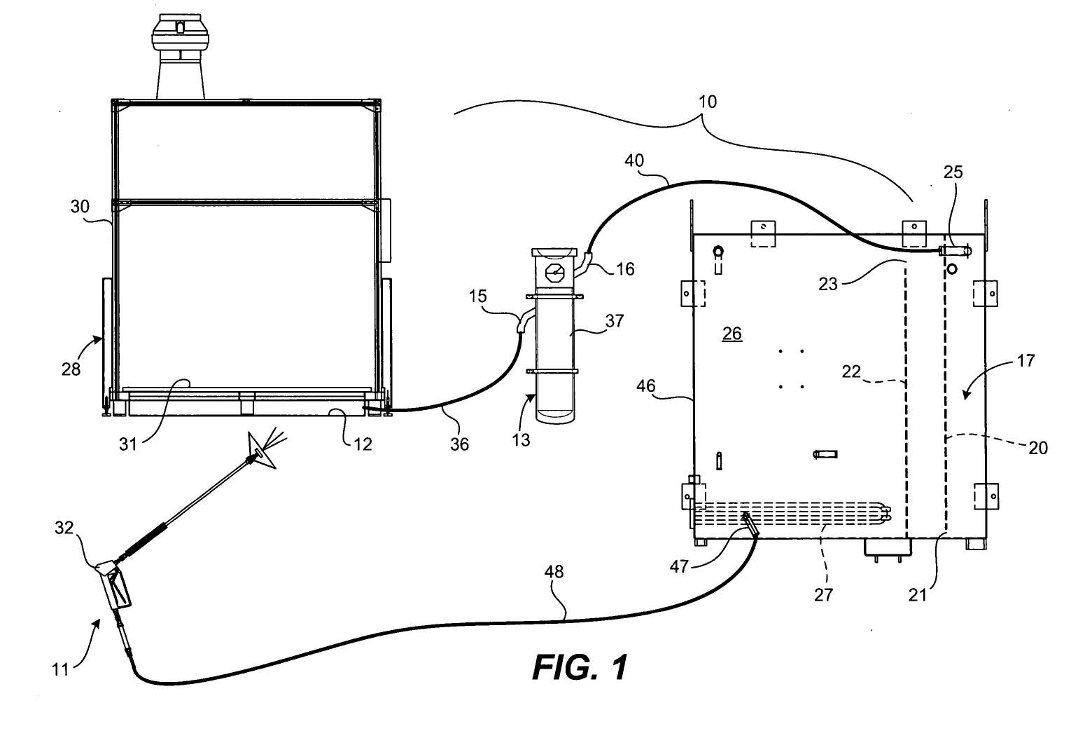

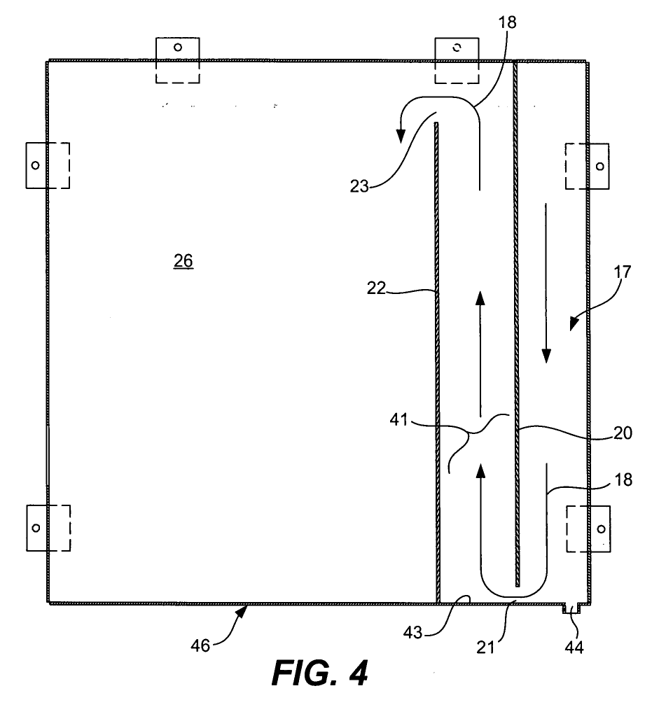

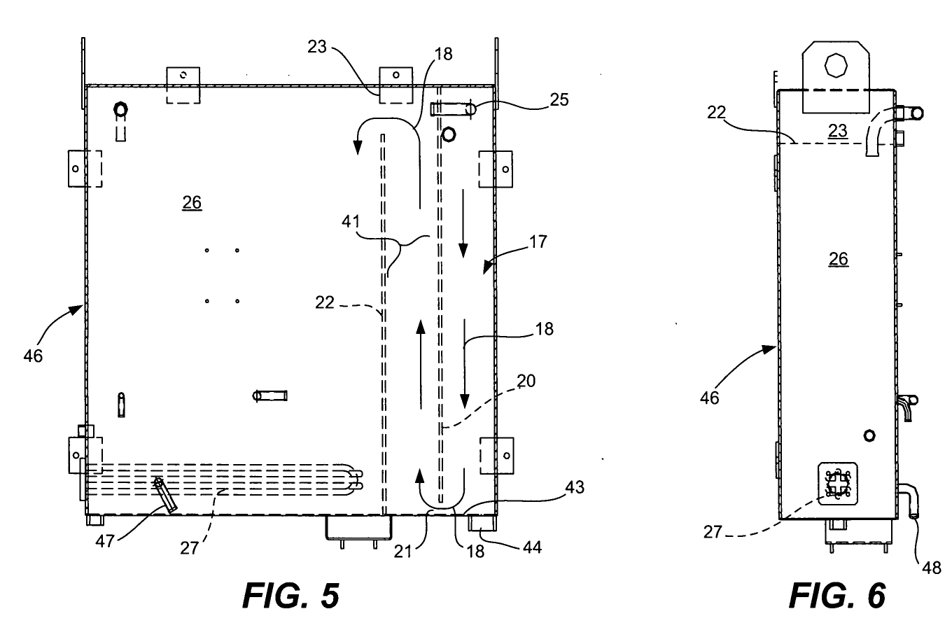

Attention is now directed to FIGS. 1-3 where a closed-loop containment assembly, generally designated 10, is illustrated for use with a pressure washing apparatus 11 for washing an object (not shown) having a low solids contaminant. The containment assembly 10 includes a fluid collection basin 12 adapted to collect the run-off of a washing fluid after being flowed over the object to remove the contaminant, and a filter assembly 13 having an inlet side 15 and an outlet side 16. The inlet side 15 is in flow communication with the contaminated washing fluid collected in the basin. A vertically upstanding clarifying tank, generally designated 17, provides a relatively vertically deep flow path (shown by arrows 18 in FIGS. 4 and 5) defined by a first baffle wall 20 downwardly distending from a top portion of the clarifying tank 17 to form an under weir 21 with a bottom portion of the clarifying tank. A second baffle wall 22 upwardly distends from the bottom portion of the clarifying tank 17 to form an over weir 23 with the top portion thereof. The clarifying tank further includes an inlet port 25 fluidly coupled to the outlet side 16 of the filter assembly 13. The inlet port 25 is positioned proximate the top portion of the tank 17, at a location upstream from the under weir 21. The containment assembly 10 further includes a relatively vertically deep clean fluid reservoir, generally designated 26, which is in fluid communication with the over weir 23 of the clarifying tank 17. The clean fluid reservoir 26 is free of any outlets configured to enable recirculation of clean washing fluid therein directly back into at least one of the filter assembly and the clarifying tank. Finally, a heating element, generally designated 27, is disposed in the clean fluid reservoir 26 to heat the clean washing fluid contained therein.

Accordingly, a low solids waste closed-loop containment assembly is provided having a vertical standing tank with a heated, non-recirculating clean fluid reservoir. Since the flow path in the clarifying tank is relatively deep vertically, preferably flowing in an upright U-shaped pattern, middle weight and light weight contaminants can be effectively gravity filtered in this clarifier. Moreover, the clean washing fluid contained in the clean fluid reservoir is heated, and is not recirculated back into either the clarifier or the filter assembly. Consequently, significantly less energy is required to heat the clean washing fluid in the clean fluid reservoir as opposed to also having to heat that in the semi-clean fluid reservoir.

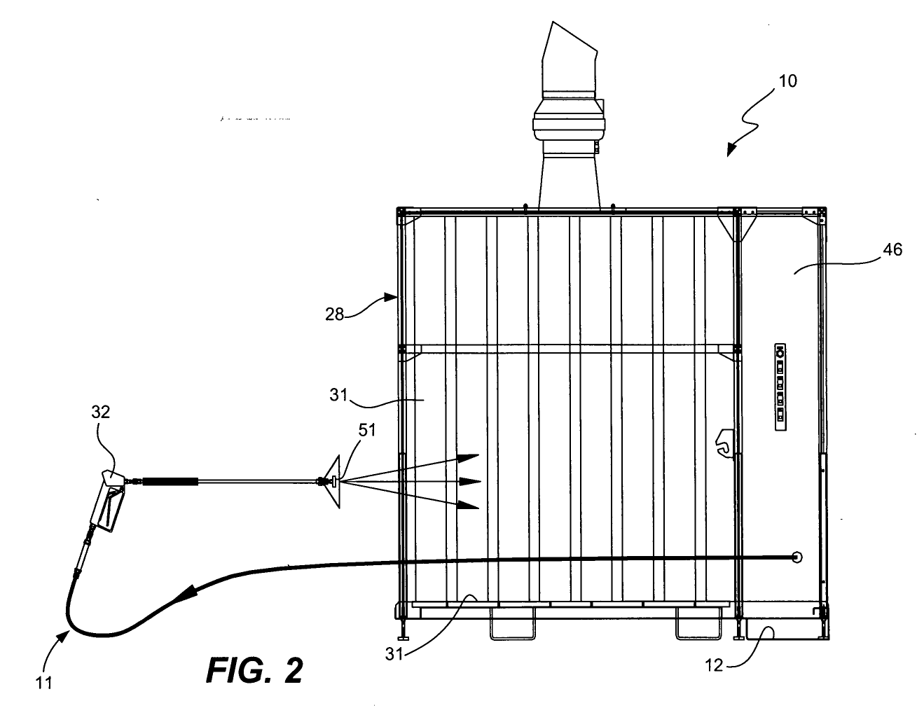

Referring back to FIGS. 1 and 2, the present invention can be coupled to any conventional washing platform assembly 28. Typically, these washing assemblies include a support platform 31 surrounded by splash walls 30. The run-off of the washing fluid from a pressure spray gun 32 of a pressure washing apparatus 11 typically collects into surrounding gutters or a collection basin 12 disposed below the platform. Typical of these pressure washing platform designs may be seen at www.pressureisland.com.

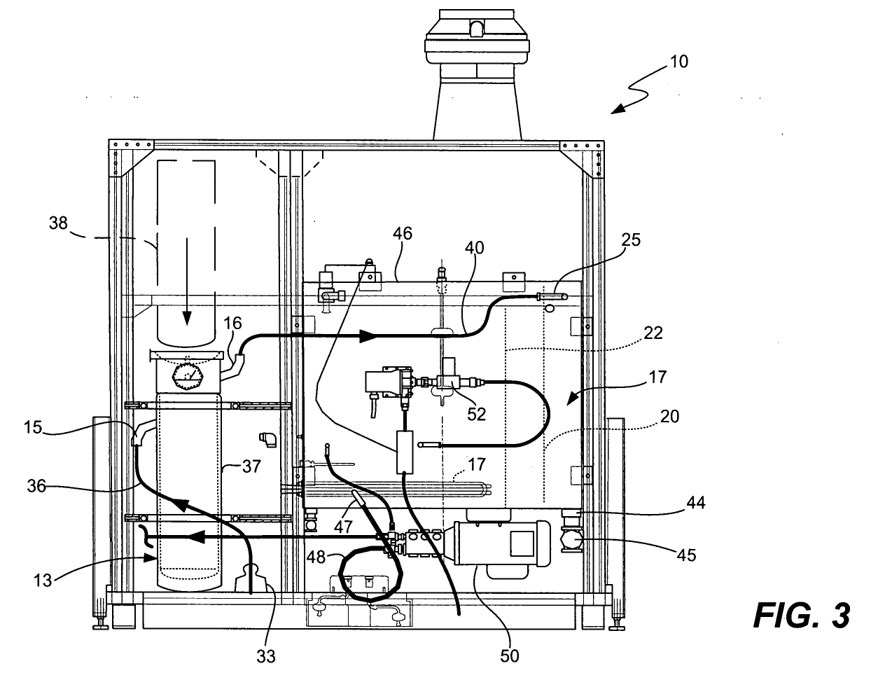

In accordance with the present invention, the run-off from the platform 31 is collected in a collection basin 12 which can be any form of gutter sump, sump tub or collection tank. A sump pump 33 (FIG. 3) is disposed in the collection basin 12 to transport the collected run-off washing fluid in the basin (or straight from the gutter) to the inlet side 15 of a filter assembly 13. A coarse mesh filter (not shown) or the like may be provided before an inlet to the sump pump to prevent larger, higher density solid contaminants (e.g., rocks) from passing through the intake of the sump pump 33 which could be damaging. However, suspended medium weight and light weight contaminants will be passed through the sump pump 33 and onto the filter assembly 13. A pump line 36 or hose fluidly couples the sump pump 33 to inlet side 15 of the filter assembly 13 for delivery of the pumped run-off washing fluid. A one-way check valve (not shown) may be included to prevent flow back from the filter assembly to the collection basin 12.

Depending upon the quantity or flow volume of the run-off washing fluids into the collection basin 12 from the support platform 31, the pumping capacity of the sump pump 33 can be selected accordingly. Moreover, the sump pump can be configured to automatically operate during the operation of the pressure washer. In one specific example, the sump pump 33 may be provided by RJM Corporation of Old Seabrook, Conn., Model No. R100, that has a pump capacity in the range of about 10 gal/min to about 15 gal/min.

As mentioned an outlet of the washing platform assembly 28 is fluidly coupled to the inlet side 15 to the filter assembly 13. Once the sump pump 33 delivers the run-off washing fluid to the filter assembly, they heavier weight and medium weight contaminants suspended in the run-off washing fluids are filtered out. These filter assemblies may be provided by filter canisters 37 having an 8″×30″ filter housing. It will be appreciated, however, that many other conventional filter assemblies may be employed as well with out departing from the true spirit and nature of the present invention.

An oil absorbing filter 38 (shown in exploded view in FIG. 6) is included which performs the function of filtering. Again, since this a low solids containment assembly 10, a 10-20 micron polypropylene filter may be applied. In other configurations, a succession of micron filters may be used to remove successively smaller particulates and molecules from the process fluid. For instance, a first filter may be deployed in the range of approximately a 100 micron filter to approximately a 150 micron filter series, which is coupled to a string-wound filter that is in the approximate range of a 30 micron to a 100 micron string-wound filter series that is, in turn, coupled to approximately a 10 micron to 30 micron polypropylene filter. The filters may generally be arranged to perform coalescing filtration by routing unfiltered water into the center of the filter, and drawing filtered water out the sides of the filter, similar to a conventional automotive oil filter. These filters may include, but are not limited to, string-wound, pleated cellulose, or polypropylene filter cartridges such as those commercially available from Met Pro Corporation, Keystone Filter Division, Hatfield, Pa., USA.

Referring now to FIGS. 1 and 3-5, the outlet side 16 of the filter assembly 13 is fluidly coupled (via tube 40) to a vertically upstanding clarifying tank 17. The upstanding tank includes a deep vertical baffle assembly 41 functioning as a clarifier between the inlet port 25 into the tank and a clean fluid reservoir 26. This deep baffle assembly 41, formed between the interior walls of the clarifying tank 17, and the first and second baffle walls 20, 22, are configured to channel the washing fluids (in the direction of arrows 18) down through an under weir 21, at the bottom of the U-shaped channel, and then up over an over weir 23, proximate the top of the channel, before flowing into the clean fluid reservoir 26. This baffle assembly 41 facilitates settling and silting of the medium and lightweight density contaminants escaping the filter assembly, which settle at the settling portion 43 of the clarifier tank 17. A purge port 44 and a valve assembly 45 positioned at the bottom of the settling portion 43 are provided to periodically purge the settle contaminants therefrom.

By providing a relatively vertically deep travel path down through the under weir 21 and up over the over weir 23, more suspended contaminant are caused to settle out from suspension, efficiently delivering quality clean fluids to the clean fluid reservoir 26. More specifically, due to deep relative vertical path (preferably U-shaped as shown by arrows 18), and to the intermittent flow nature of this sump pump, the washing fluid contained in the clarifier for a sufficient period of time to enable middle weight and light weight contaminants to be effectively gravity filtered out. For instance, by specifying the sump pump to produce a relatively low flow into the clarifier portion of the tank, the fluids (and contaminants) can enter the tank at the lowest possible velocity and pressure. This low velocity and pressure minimizes turbulence in the clarifier that may “stir up” the settled contaminants. In contrast, when the fluid enters the tank at high flow rates and pressures, the fluid “stirs up” the contaminants that have settled to the bottom of the tank and will sometimes cause them to flow over the over weir into the clean water compartment portion of the tank.

Another technique to reduce contaminant flow over the over weir is to use a sump pump to output fluids into the clarifier at intervals rather than at a constant flow. This technique provides even more time for the solids to settle out from the fluids.

The high walls of the over weir also provide a first stage of filtration for large and medium weight solids. When these walls sit in the gutter in this machine, primarily only fluids and dissolved solids are able to pass into the collection basin, under the wall to gutter interface, along with some contaminants (about 0.125-0.200 of an inch in cross section).

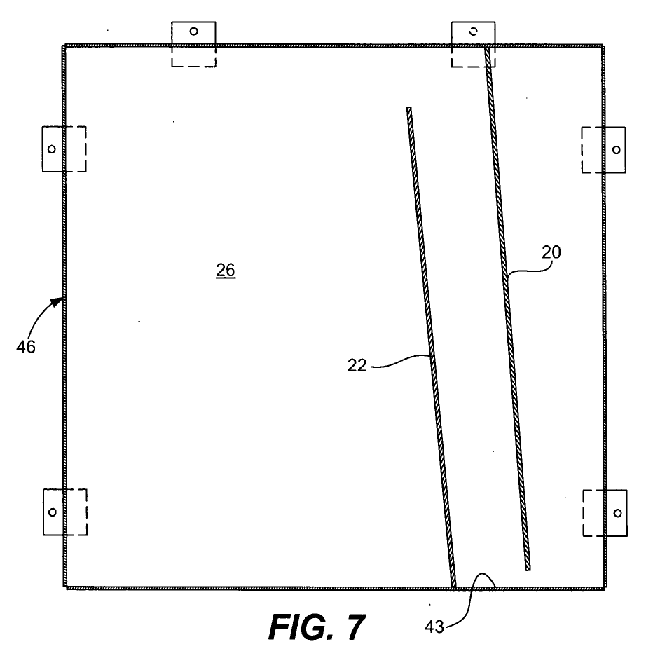

In one specific embodiment, the first and second baffle walls 20, 22 are substantially vertical. As shown in FIG. 4, hence, the baffle walls are substantially parallel one another. In an alternative embodiment, as shown in FIG. 7, the second baffle wall 22 slightly tapers away from the first baffle wall 20 in a direction from the bottom portion of the clarifying tank to the top portion thereof.

In the preferred form, the clarifying tank 17 and the clean fluid reservoir 26 may be integral in a single-unit, vertically upstanding storage tank 46. To resist corrosion and improve durability, the storage tank 46 is preferably stainless steel. The clarifying reservoir 26, in accordance with the present invention, is a non-recirculating storage facility that houses a heating element 27 therein. This arrangement of the clean fluid reservoir in a closed-loop pressure washing assembly is beneficial in that the heated water is not recirculated back into the clarifying reservoir like the current systems are. Hence, the capacity of washing fluid that requires heating is significantly less, which is more energy efficient and decreases the time required to heat the fluid therein.

As best shown in FIGS. 5 and 6, the clean fluid reservoir 26 is also proportionately tall, which is significant in that should the heating element 27 bring the heated fluids to a boil, it will not spill back over the over weir into the clarifying tank 17. In the preferred embodiment, not less than 1:1 height to width, and more preferable proportion is 1.3 (height) to 1 (width).

The heating element 27 disposed in the clean fluid reservoir is preferably provided by a flange mounted, 3-element 480 volt heater. This element is preferably positioned near the bottom of the reservoir to assure submersion in the clean washing fluid therein. This may be provided by any conventional heating element capable of heating the washing fluid to a substantially high temperature in the range of about 80° F. to about 212° F., and more preferably in the range of about 140° F. to about 160° F. To regulate and sense the temperature, a standard RTD probe is applied

As viewed in FIG. 3, at the bottom of the clean fluid reservoir 26 is an outlet port 47 that gravity feeds (via line 48) the heated washing fluid to a pressure pump 50, which in turn is fed to a conventional spray pressure washer 11. This pressure pump 50 can be configured to automatically operate during the operation of the spray pressure washer wand 11. In one specific example, the pressure pump 50 may be provided by UDOR, spa of Rubiera, Italy Model No. PND 2.0/202 that has a pump capacity in the range of about 1.8 gal/min to about 2.2 gal/min.

A plurality of water level switches is provided to gauge the level of the fluids contained within the tank compartments. This is specifically to assure adequate reserve space for washing fluids until the system reaches equilibrium. For instance, a four level float stick strategically placed in the clean water section of the tank, vertically in the heated chamber, provides adequate fluid level variation control, and should be mounted from the top of the tank.

As mentioned, the outlet of the pressure pump 50 is fluidly coupled to a conventional spray pressure washing apparatus 11 to pressure wash the object using a conventional pressure wand or gun 32 and a compatible spray nozzle 51 (FIGS. 1 and 2). The pressure pump can be provided any conventional high-pressure pump assembly, and is preferably capable of delivering a variable pressure for a selective pressure spray application. One such conventional pressure pump, for example, is that provided by WANNER, Model No. MD3EABJSSECA, which is capable of providing a low-pressure spray in the range of about 50 psi and a high-pressure spray in the range of about 3000 psi.

When the machine is not in the wash mode an included ozonation system 52 may be applied to ozonate the process fluid in the sump tank. As set forth in U.S. Pat. No. 5,785,067, which is incorporated by reference, ozonation is highly beneficial since it is highly oxidizing, and will attack substantially any contamination in the water. Briefly, the ozonation system 52 includes a recirculation pump that draws process fluid from the clean fluid reservoir 26 through an inlet and into recirculation line. Once the process fluid is drawn into the recirculation line from the recirculation pump, the process fluid flows through a gas-liquid mixing device, such as a venturi-type injector. The injector is further coupled to an ozone generator, such as the model CS-1200 available commercially from Clearwater Technologies, which is capable of generating 0.25 grams of ozone per hour.

Essentially, the heated washing fluid from the clean fluid reservoir is passed through the ozone pump, the venturi injector and then straight to the sump tank. This ozone enriched washing fluid is then passed through the filter housing, the clarifier and the clean fluid reservoir to prevent and/or reduce odors from occurring. In this arrangement, the ozonated water is caused to directly attack the bacteria and associated odors from the run-off process fluid in the collection compartment and in the separation compartment.

What is claimed is:

1. A closed-loop containment assembly for use with a pressure washing apparatus for washing an object having a contaminant comprising:
a fluid collection basin adapted to collect the run-off of a washing fluid after being flowed over the object to remove the contaminant;
a filter assembly having an inlet side and an outlet side, said inlet side in fluid communication with the contaminated washing fluid collected in said basin;
a clarifying tank having an upper positioned inlet in flow communication with the outlet side of the filter assembly, and including a baffle assembly defining an under weir at a bottom portion of the clarifying tank and a downstream over weir at an upper portion of the clarifying tank such that a relatively vertically deep flow path down under the under weir and up over the over weir is defined;
a relatively vertically deep clean fluid reservoir in fluid communication with said over weir of the clarifying tank, said clean fluid reservoir being free of any outlets configured to enable recirculation of clean washing fluid therein directly back into at least one of said filter assembly and said clarifying tank; and
a heating device configured to heat the clean washing fluid contained in said clean fluid reservoir to heat.

2. The containment assembly as defined in claim 1, wherein
said flow path of said clarifying tank is substantially U-shaped.

3. The containment assembly as defined in claim 1, wherein
said clarifying tank is vertically upstanding and said baffle assembly includes a first baffle wall downwardly distending from the tank top portion to form said under weir with the tank bottom portion of the clarifying tank, and a second baffle wall upwardly distending from the tank bottom portion to form said over weir with the tank top portion thereof.

4. The containment assembly as defined in claim 3, wherein
the inlet into the clarifying tank is positioned proximate the tank top portion, upstream from said under weir.

5. The containment assembly as defined in claim 3, wherein
said flow path of said clarifying tank is substantially U-shaped.

6. The containment assembly as defined in claim 5, wherein
said first baffle wall and said second baffle wall are substantially vertical.

7. The containment assembly as defined in claim 5, wherein
said second baffle wall tapers away from said first baffle wall from the tank bottom portion the tank top portion.

8. The containment assembly as defined in claim 1, further including:
a sump pump coupled between the collection basin and the inlet side of the filter assembly.

9. The containment assembly as defined in claim 1 wherein,
said filtering assembly includes a canister filter.

10. The containment assembly as defined in claim 1 further including:
an ozonator coupled to dispense ozonated driving fluid into the contaminated washing fluid contained in the collection basin.
